(19) United States
(12) Patent Application Publication
(10) Pub. No.: US 2011/0071889 A1
(43) Pub. Date: Mar. 24, 2011

(54) Location-Aware Retail Application

(75) Inventors: George William Erhart, Loveland, CO (US); Valentine C. Matula, Granville, OH (US); David Joseph Skiba, Golden, CO (US)

(73) Assignee: Avaya Inc., Basking Ridge, NJ (US)

(21) Appl. No.: 12/566,558

(22) Filed: Sep. 24, 2009

(51) Int. Cl. G06Q 30/00

(52) U.S. Cl. 705/14.16; 705/14.58; 705/319; 705/1.1; 705/26.7

(57) ABSTRACT

A method and apparatus are disclosed for potentially increasing sales of a retail organization using location-based technology. The illustrative embodiment comprises a location-aware application that can infer when a first customer is potentially interested in purchasing a particular item during a visit to a retail location, and can infer when there is a second customer at the retail location who is familiar with that item (e.g., a customer who previously purchased that item, etc.). When such a match occurs, the second customer is notified of the presence of the first customer, and of the first customer's potential interest in purchasing the item, and is encouraged to provide assistance to the first customer (e.g., discuss features of the item with the first customer, discuss advantages of the item in comparison to other items, etc.).

### FIELD OF THE INVENTION

The present invention relates to telecommunications in general, and, more particularly, to a location-aware retail application.

### BACKGROUND OF THE INVENTION

Geo-location capabilities are becoming increasingly common in wireless telecommunications terminals (e.g., cell phones, smartphones such as the iPhone® and Blackberry®, etc.) due to the proliferation of Global Positioning System (GPS) receivers built into such terminals, as well as other techniques for estimating the location of terminals (e.g., schemes based on Wi-Fi hotspots, radio frequency [RF] fingerprinting, etc.).

### SUMMARY OF THE INVENTION

The present invention comprises an apparatus and method for potentially increasing sales by a retail organization (e.g., an electronics superstore chain, a department store chain, etc.). In particular, the illustrative embodiment comprises a location-aware application that can infer when a first customer is potentially interested in purchasing a particular item during a visit to a retail location, and can infer when there is a second customer at the retail location who is familiar with that item (e.g., a customer who previously purchased that item, etc.). When such a match occurs (and the first and second customers have provided appropriate consent), the second customer is notified of the presence of the first customer, and of the first customer's potential interest in purchasing the item, and is encouraged—perhaps by the offer of a reward—to provide assistance to the first customer (e.g., discuss features of the item with the first customer, discuss advantages of the item in comparison to other items, etc.). Optionally, the first customer is also notified of the presence of the second customer, thereby avoiding any potential surprise or alarm if the second customer does in fact approach the first customer.

The illustrative embodiment comprises: receiving a first signal that indicates that a first user is at a retail location; inferring that the first user is potentially interested in purchasing an item that is sold at the retail location; inferring that there is a second user currently at the retail location who is familiar with the item; and transmitting to a telecommunications terminal associated with the second user a second signal that informs the second user: (i) of the presence of the first user, and (ii) that the first user is potentially interested in purchasing the item.

### BRIEF DESCRIPTION OF THE DRAWINGS

FIG. 1 depicts the salient elements of a telecommunications system, in accordance with the illustrative embodiment of the present invention.

FIG. 2 depicts the salient elements of telecommunications network 102, as shown in FIG. 1, in accordance with the illustrative embodiment of the present invention.

FIG. 3 depicts a flowchart of the salient tasks of the illustrative embodiment of the present invention.

### DETAILED DESCRIPTION

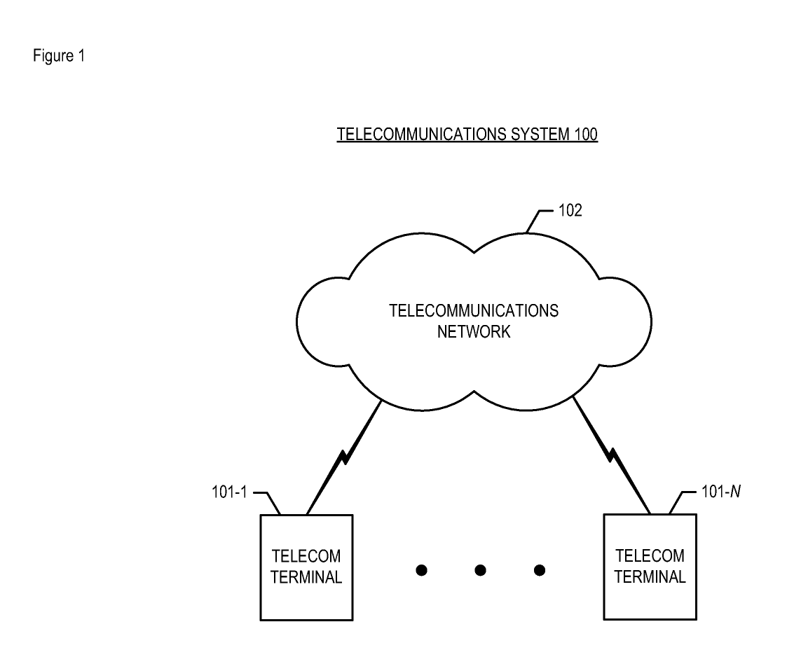

FIG. 1 depicts the salient elements of telecommunications system 100, in accordance with the illustrative embodiment of the present invention. As shown in FIG. 1, telecommunications system 100 comprises wireless telecommunications terminals 101-1 through 101-N, where N is a positive integer, and telecommunications network 102, interconnected as shown. Each wireless telecommunications terminal 101-i, where i is an integer between 1 and N inclusive, is one of a cell phone, a smartphone (e.g., an Apple iPhone®, a Research in Motion Blackberry®, etc.), a netbook, etc. that is capable of transmitting and receiving messages via telecommunications network 102, in well-known fashion.

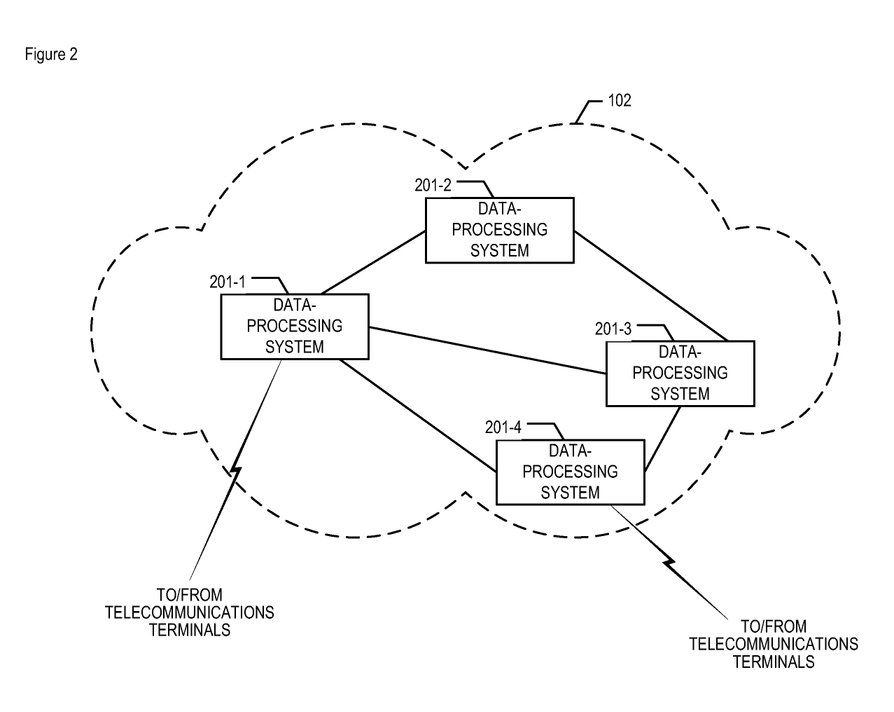

FIG. 2 depicts an illustrative block diagram of the salient components of telecommunications network 102, in accordance with the illustrative embodiment of the present invention. As shown in FIG. 2, telecommunications network 102 comprises a plurality of data-processing systems 201-i for i=1 to 4, interconnected as shown. Each data-processing system 201-i might be a switch, a private branch exchange (PBX), a server, a wireless base station, a wireless switching center, and so forth. As will be appreciated by those skilled in the art, although data-processing systems 201-1 through 201-4 are denoted by the same prefix 201, element 201-1 might be a switch, while element 201-2 might be a wireless base station, etc. Similarly, the fact that telecommunications network 102 has four elements 201 in FIG. 2 is merely illustrative; telecommunications network 102 might have fewer elements, or a greater number of elements, than that depicted.

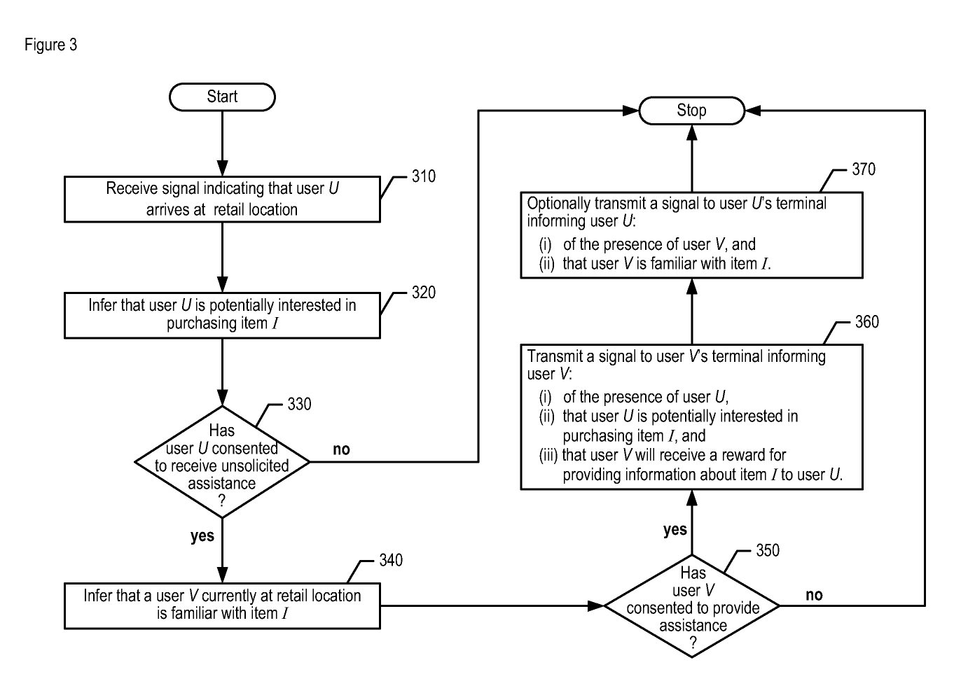

FIG. 3 depicts a flowchart of the salient tasks of the illustrative embodiment of the present invention. It will be clear to those skilled in the art, after reading this disclosure, which tasks depicted in FIG. 3 can be performed simultaneously or in a different order than that depicted.

At task 310, a data-processing system receives a signal that indicates that a user U of one of wireless telecommunications terminals 101-1 through 101-N has arrived at a retail location of a particular organization (e.g., a Best Buy® store, a Home Depot® store, etc.). As will be appreciated by those skilled in the art, in some embodiments of the present invention, user U's arrival at the retail location might be detected based on a Global Positioning System (GPS) receiver built into user U's terminal, while in some other embodiments, user U's arrival at the retail location might be detected in some other manner (e.g., via a Wi-Fi hotspot at the retail location, via Bluetooth, etc.).

At task 320, a data-processing system infers that user U is potentially interested in purchasing an item I that is sold at the retail location. In accordance with the illustrative embodiment, the inference of task 320 is based on one or more of the following:
(i) user U being in the vicinity of item I at the retail location for a length of time exceeding a threshold;
(ii) user U having a Web shopping cart or wish list (e.g., a Walmart.com shopping cart, an Amazon.com wish list) that contains item I; and
(iii) user U performing an Internet search related to item I (e.g., a Google search, a pricegrabber.com price comparison search, a search of the website of the item's manufacturer, etc.) on his or her telecommunications terminal while at the retail location.

As will be appreciated by those skilled in the art, there are a variety of ways in which condition (i) might be detected. For example, in some embodiments it might be ascertained that user U is close to a particular item based on the location of user U's terminal and a floor plan of the retail location, while in some embodiments user U's proximity to an item might be determined in some other fashion.

As will further be appreciated by those skilled in the art, there are a variety of ways in which condition (ii) might be ascertained. For example, in some embodiments an Internet browser “cookie” file on user U's terminal might indicate for which commerce websites user U has a shopping cart; while in some other embodiments an Internet browser cache might be consulted to determine which commerce sites user U has recently visited, and those websites then checked for a shopping cart for user U; while in still some other embodiments, a set of popular commerce websites (e.g., Amazon.com, bestbuy.com, etc.) might be checked for a shopping cart for user U.

As will yet further be appreciated by those skilled in the art, in some other embodiments of the present invention, the inference of task 320 might be based on one or more other conditions, either instead of, or in addition to, those of the illustrative embodiment (e.g., an Internet search related to the item performed by user U within the last 24 hours, etc.), and it will be clear to those skilled in the art, after reading this disclosure, how to make and use such embodiments.

As will still further be appreciated by those skilled in the art, in some embodiments of the present invention, the data-processing system that performs task 320 might be the same as the data-processing system that performs task 310 (e.g., both tasks performed by user U's telecommunications terminal, both tasks performed by a data-processing system of telecommunications network 102, etc.), while in some other embodiments, tasks 310 and 320 might be performed by different data-processing systems (e.g., task 310 performed by user U's telecommunications terminal and task 320 another by a data-processing system of telecommunications network 102, tasks 310 and 320 performed by two different data-processing systems of telecommunications network 102, etc.).

At task 330, a data-processing system checks whether user U has consented to receive unsolicited assistance from other customers (e.g., by proactively indicating so in a Web page sign-up form, by failing to change a default privacy setting from ‘allow’ to ‘disallow’, etc.). If so, execution continues at task 340, otherwise, the method of FIG. 3 terminates.

As will be appreciated by those skilled in the art, in some embodiments of the present invention, the data-processing system that performs task 330 might be the same as the data-processing system that performs task 310, or the same as the data-processing system that performs task 320, or both, while in some other embodiments, the data-processing system that performs task 330 might be different than the one(s) performing tasks 310 and 320.

At task 340, a data-processing system infers that a user V of another one of wireless telecommunications terminals 101-1 through 101-N who is currently at the retail location is familiar with item I. As will be appreciated by those skilled in the art, in some embodiments of the present invention, user V's presence at the retail location might be detected based on a Global Positioning System (GPS) receiver built into user V's terminal, while in some other embodiments, user V's presence at the retail location might be detected in some other manner (e.g., via a Wi-Fi hotspot at the retail location, via Bluetooth, etc.).

In accordance with the illustrative embodiment, the inference that user V is familiar with item I is based on one or more of the following:
(i) user V has previously purchased item I;
(ii) user V has reviewed item I on a website or blog; and
(iii) user V contributed to a discussion about item I on a website.

As will be appreciated by those skilled in the art, there are a variety of ways in which condition (i) might be detected. For example, in some embodiments it might be ascertained that user V has previously purchased item I based on a database of recent purchases or a customer loyalty program database, while in some other embodiments condition (i) might be ascertained based on a warranty database associated with a manufacturer (e.g., Sony, Samsung, etc.) or an extended-warranty program associated with the retailer, while in still some other embodiments condition (i) might be determined in some other fashion.

As will further be appreciated by those skilled in the art, there are a variety of ways in which condition (ii) might be ascertained. For example, if item I is a flat-panel television, in some embodiments an Internet browser cache might be consulted to determine relevant websites on which user V might have reviewed item I (e.g., Amazon.com, bestbuy.com, etc.), while in some other embodiments condition (ii) might be determined in some other fashion.

As will further be appreciated by those skilled in the art, there are a variety of ways in which condition (iii) might be ascertained. For example, if item I is a stereo system, in some embodiments an Internet browser cache might be consulted to determine relevant websites on which user V might have discussed item I (e.g., avsforum.com, audioasylum.com, etc.), while in some other embodiments condition (iii) might be determined in some other fashion.

As will be appreciated by those skilled in the art, in some other embodiments of the present invention, the inference that user V is familiar with item I might be based on one or more other conditions, either instead of, or in addition to, those of the illustrative embodiment (e.g., user V regularly visits the retail location, user V regularly visits a particular department in the retail location, etc.), and it will be clear to those skilled in the art, after reading this disclosure, how to make and use such embodiments.

As will further be appreciated by those skilled in the art, in some embodiments of the present invention, the data-processing system that performs task 340 might be the same as one of the data-processing systems performing one or more of tasks 310 through 330, while in some other embodiments, the data-processing system that performs task 340 might be different than the one(s) performing tasks 310 through 330.

At task 350, a data-processing system checks whether user V has consented to receive notifications pertaining to the providing of assistance to other customers (e.g., by proactively indicating so in a Web page sign-up form, by failing to change a default privacy setting from ‘allow’ to ‘disallow’, etc.) If so, execution continues at task 360, otherwise, the method of FIG. 3 terminates.

As will be appreciated by those skilled in the art, in some embodiments of the present invention, the data-processing system that performs task 350 might be the same as one of the data-processing systems performing one or more of tasks 310 through 340, while in some other embodiments, the data-processing system that performs task 350 might be different than the one(s) performing tasks 310 through 340.

At task 360, a data-processing system transmits a signal to user V's telecommunications terminal, where the signal informs user V: (i) of the presence of user U, (ii) that user U is potentially interested in purchasing item I, and (iii) that user V will receive a reward for providing information about item I to user U.

As will be appreciated by those skilled in the art, in some other embodiments of the present invention, the signal transmitted at task 360 might provide other information instead of, or in addition to, that of the illustrative embodiment. For example, in some other embodiments of the present invention, the signal might inform user V that he or she will receive a reward for providing information about item I to user U provided that user U purchases item I during his or her current visit to the retail location, while in some other embodiments, the signal might inform user V that he or she will receive a reward for providing information about item I to user U if user U purchases either item I or an alternative item of the same type as item I (e.g., a different model, a different brand, etc.) during his or her current visit to the retail location. Alternatively, in yet some other embodiments of the present invention, the signal transmitted at task 360 might inform user V that he or she will receive a reward for providing information about item I to user U whenever user U purchases item I from the organization (e.g., during the current visit to this particular Best Buy® store, during a future visit to any Best Buy® store, via the bestbuy.com website, etc.).

As will further be appreciated by those skilled in the art, in some embodiments of the present invention, the data-processing system that performs task 360 might be the same as one of the data-processing systems performing one or more of tasks 310 through 350, while in some other embodiments, the data-processing system that performs task 360 might be different than the one(s) performing tasks 310 through 350.

At optional task 370, a signal is transmitted to user U's telecommunications terminal that informs user U: (i) of the presence of user V, and (ii) that user V is familiar with item I. As will be appreciated by those skilled in the art, the signal of task 370 might result in user U proactively seeking out user V, or might simply “prepare” user U for the possibility of being approached by user V.

As will further be appreciated by those skilled in the art, in some other embodiments of the present invention, the signal transmitted at optional task 370 might provide other information instead of, or in addition to, that of the illustrative embodiment. For example, maybe description of user V, maybe tell U about reward that V will get, maybe offer reward to U too if buy at current visit, etc.

As will yet further be appreciated by those skilled in the art, in some embodiments of the present invention, the data-processing system that performs optional task 370 might be the same as one of the data-processing systems performing one or more of tasks 310 through 360, while in some other embodiments, the data-processing system that performs optional task 370 might be different than the one(s) performing tasks 310 through 360.

As will still further be appreciated by those skilled in the art, in some other embodiments of the present invention, optional task 370 might be omitted altogether.

After optional task 370, the method of FIG. 3 terminates.

As will be appreciated by those skilled in the art, in some embodiments of the present invention, one or more of the tasks of the method of FIG. 3 might be implemented via rules of a geo-spatial grammar (co-pending U.S. patent application Ser. No. 12/561,459, Attorney Docket 630-408us, entitled “Speech-Recognition System For Location-Aware Applications,” incorporated by reference), while in some other embodiments, the tasks of this method might be implemented via a conventional algorithm. In any case, it will be clear to those skilled in the art, after reading this disclosure, how to make and use embodiments of the present invention that implement the method of FIG. 3.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving a first signal that indicates that a first user is at a retail location;
inferring that said first user is potentially interested in purchasing an item that is sold at said retail location;
inferring that there is a second user currently at said retail location who is familiar with said item; and
transmitting to a telecommunications terminal associated with said second user a second signal that informs said second user:
(i) of the presence of said first user, and
(ii) that said first user is potentially interested in purchasing said item.

2. The method of claim 1 wherein the inference that said second user is familiar with said item is based on a previous purchase by said second user.

3. The method of claim 1 wherein the inference that said second user is familiar with said item is based on a review by said second user.

4. The method of claim 1 wherein said second signal also informs said second user:
(iii) that said second user will receive a reward for providing information about said item to said first user.

5. The method of claim 1 wherein said second signal also informs said second user:
(iii) that said second user will receive a reward for providing information about said item to said first user when said first user purchases said item during said first user's current visit to said retail location.

6. The method of claim 1 further comprising:
transmitting a third signal to a telecommunications terminal associated with said first user that informs said first user:
(i) of the presence of said second user, and
(ii) that said second user is familiar with said item.

7. The method of claim 1 wherein the inference that said first user is potentially interested in purchasing said item is based on the contents of a Web shopping cart associated with said first user.

8. The method of claim 1 wherein the inference that said first user is potentially interested in purchasing said item is based on said first user being in the vicinity of said item at said retail location for at least N seconds, wherein N is a positive real number.

9. A method comprising:
(a) receiving a first signal that indicates that:
(i) a first user is at a retail location, and
(ii) said first user is potentially interested in purchasing an item that is sold at said retail location;
(b) inferring that there is a second user currently at said retail location who is familiar with said item; and
(c) transmitting to a telecommunications terminal associated with said second user a second signal that informs said second user:
(i) of the presence of said first user, and
(ii) that said first user is potentially interested in purchasing said item.

10. The method of claim 9 wherein the inference that said second user is familiar with said item is based on a previous purchase by said second user.

11. The method of claim 9 wherein said second signal also informs said second user:
(iii) that said second user will receive a reward for providing information about said item to said first user when said first user purchases said item from an organization associated with said retail location.

12. The method of claim 9 further comprising:
(d) transmitting a third signal to a telecommunications terminal associated with said first user that informs said first user:
(i) of the presence of said second user, and
(ii) that said second user is familiar with said item.

13. The method of claim 9 wherein said first user's potential interest in purchasing said item is inferred from said first user performing an Internet search related to said item during said first user's current visit to said retail location.

14. The method of claim 9 wherein said first user's potential interest in purchasing said item is inferred from said first user being in the vicinity of said item at said retail location for at least N seconds, wherein N is a positive real number.

15. A method comprising:
(a) receiving one or more signals that indicate that:
(i) a first user is currently at a retail location,
(ii) said first user is potentially interested in purchasing an item that is sold at said retail location,
(iii) there is a second user currently at said retail location who is familiar with said item; and
(b) transmitting a first signal to a telecommunications terminal associated with said second user in response to said one or more signals;
wherein said first signal informs said second user:
(i) of the presence of said first user, and
(ii) that said first user is interested in purchasing said item.

16. The method of claim 15 wherein said second user's familiarity with said item is inferred from said second user having previously purchased said item.

17. The method of claim 15 wherein said second user's familiarity with said item is inferred from said second user having contributed to a discussion about said item on a website.

18. The method of claim 15 further comprising:
(c) transmitting a third signal to a telecommunications terminal associated with said first user that informs said first user:
(i) of the presence of said second user, and
(ii) that said second user is familiar with said item.

19. The method of claim 15 wherein said first user's interest in purchasing said item is inferred from said first user performing an Internet search related to said item during said first user's current visit to said retail location.

20. The method of claim 15 wherein said first user's interest in purchasing said item is inferred from said first user being in the vicinity of said item at said retail location for at least N seconds, wherein N is a positive real number.
